(19) United States
(12) Patent Application Publication
(10) Pub. No.: US 2014/0343762 A1
(43) Pub. Date: Nov. 20, 2014

(54) DEVICE AND METHOD TO INCREASE PILOT FOCUS

(71) Applicant: AIRBUS OPERATIONS S.A.S., Toulouse Cedex (FR)

(72) Inventors: Florence Buratto, Plaisance Du Touch (FR); Amelie Beaudroit, Toulouse (FR)

(73) Assignee: AIRBUS OPERATIONS S.A.S., Toulouse Cedex (FR)

(21) Appl. No.: 13/895,802

(22) Filed: May 16, 2013

(51) Int. Cl. B64C 19/00

(52) U.S. Cl. CPC B64C 19/00
USPC 701/14

(57) ABSTRACT

An interactive task organizer application may encourage a pilot to be more alert and engaged while operating the aircraft, despite that automation has made the job more passive. The interactive task organizer application may have access to flight data, and may use this data to create a virtual environment that encourages pilots to perform flight related tasks and to make visible explicit mission goals at a global and local level.

### BACKGROUND OF THE INVENTION

In modern aircrafts, piloting tasks are more and more automated. Due to automation, pilots may lose their concentration in operating the aircraft for several seconds and may become less motivated to perform their job diligently. Such lack of concentration and motivation has to be avoided, as the pilot needs to be alert while operating the aircraft.

### BRIEF SUMMARY OF THE INVENTION

Aspects of the disclosure relate generally to an interactive task organizer application that encourages a pilot to be more alert and engaged while operating the aircraft.

One aspect of the disclosure provides a method, comprising providing an interface, accessing flight information from an avionics system, determining, using a processor, a flight phase based on the flight information, providing a list of tasks for the determined flight phase to the user through the interface, determining whether an operator has completed the tasks on the list, and computing, using the processor, a reward for the operator based on the operator's completion of tasks in the list of tasks.

Another aspect of the disclosure provides a system, comprising an interface, a processor, and a memory in communication with the processor. The memory may store instructions executable by the processor for performing a method, the method comprising accessing flight information from an avionics system, determining a flight phase based on the flight information, providing a list of tasks for the determined flight phase to the user through the interface, determining whether an operator has completed the tasks on the list, and computing a reward for the operator based on the operator's completion of tasks in the list of tasks.

Yet another aspect of the disclosure provides a non-transitory computer readable medium storing instructions executable by a processor to perform a method, the method comprising accessing flight information from an avionics system, determining a flight phase based on the flight information, providing a list of tasks for the determined flight phase to the user through the interface, determining whether an operator has completed the tasks on the list, and computing a reward for the operator based on the operator's completion of tasks in the list of tasks.

### BRIEF DESCRIPTION OF THE DRAWINGS

FIG. 1 is a perspective view of a system in accordance with an aspect of the disclosure implemented within a cockpit of an airplane.

FIG. 2 is a functional diagram of a system in accordance with an aspect of the disclosure.

FIG. 3 is an illustration including example screen shots in accordance with an aspect of the disclosure.

FIG. 4A is an example screen shot in accordance with an aspect of the disclosure.

FIG. 4B is an illustration including another example screen shot in accordance with an aspect of the disclosure.

FIG. 5 is an illustration including another example screen shot in accordance with an aspect of the disclosure.

FIG. 6 is an illustration including another example screen shot in accordance with an aspect of the disclosure.

FIG. 7 is an illustration including another example screen shot in accordance with an aspect of the disclosure.

FIG. 8 is another example screen shot in accordance with an aspect of the disclosure.

FIG. 9 is another example screen shot in accordance with an aspect of the disclosure.

FIG. 10 is another example screen shot in accordance with an aspect of the disclosure.

FIG. 11 is a flow diagram illustration a method in accordance with an aspect of the disclosure.

### DETAILED DESCRIPTION

An interactive task organizer application encourages a pilot to be more alert and engaged while operating the aircraft, despite that automation has made the job more passive. The interactive task organizer application has access to flight data, and uses this data to create a virtual environment that encourages pilots to perform flight related tasks and to make visible explicit mission goals at a global and local level. The application is implemented on a device arranged in the cockpit, where it can be used during all phases of flight when the pilot has the availability. While the application is described herein with reference to an aircraft, it should be understood that the application may be used in any of a variety of other instances. For example, the application may be implemented in an autonomous car, a boat, or other vehicles and non-vehicles.

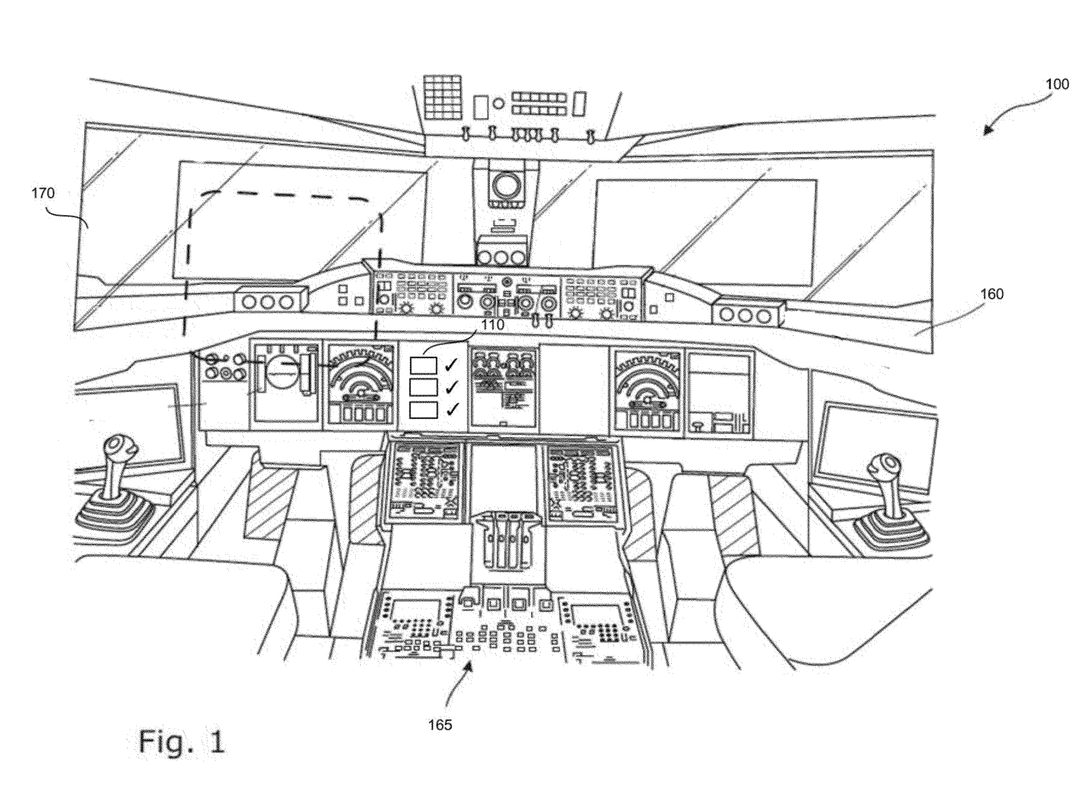

FIG. 1 provides an example of the application implemented on a computer 110 in a cockpit 100. As shown, the device 110 is arranged among other aviation controls, such as on a dashboard 160 below windshield 170. In other examples, the computer 110 is arranged in a console 165, side panel, seat attachment, or the like. In this regard, the pilot may easily access the application while maintaining control of the aircraft. Additionally, the application may be more conveniently interfaced with an avionics system of the aircraft.

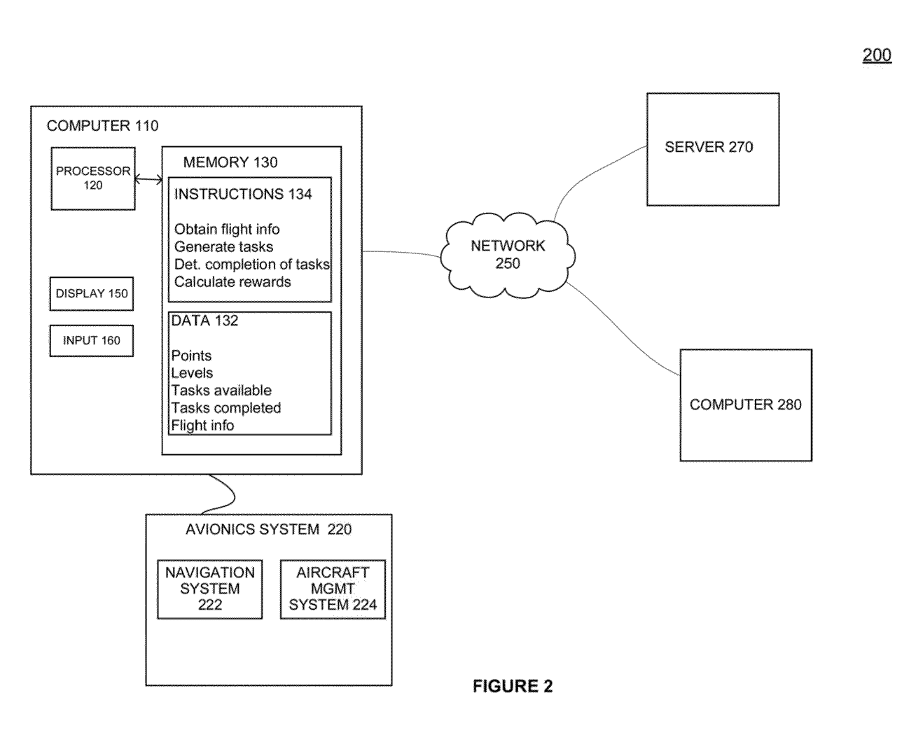

As shown in FIG. 2, a system 200 in accordance with one aspect of the invention includes the computer 110 containing a processor 120, memory 130 and other components typically present in general purpose computers.

The memory 130 stores information accessible by processor 120, including instructions 132, and data 134 that may be executed or otherwise used by the processor 120. For example, the processor 120 executes data and instructions to run the interactive task organizer application. The memory 130 may be of any type capable of storing information accessible by the processor, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, memory may include short term or temporary storage as well as long term or persistent storage. Systems and methods in accordance with aspects of the invention may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” are used interchangeably herein. The instructions may be stored in object code format for direct processing by the processor, or in any other computer language including scripts or collections of independent source code modules that are interpreted on demand or compiled in advance. Functions, methods and routines of the instructions relate to aspects of the interactive task organizer application. Such functions, methods, and routines include, for example, obtaining flight information, generating tasks relating to the flight information, determining completion of the tasks, and calculating rewards based on the completion of the tasks.

The data 134 may be retrieved, stored or modified by processor 120 in accordance with the instructions 132. For instance, although the architecture is not limited by any particular data structure, the data may be stored in computer registers, in a relational database as a table having a plurality of different fields and records, XML documents or flat files. The data is also formatted in any computer-readable format. By further way of example only, image data is stored as bitmaps comprised of grids of pixels that are stored in accordance with formats that are compressed or uncompressed, lossless or lossy, and bitmap or vector-based, as well as computer instructions for drawing graphics. The data comprise any information sufficient to identify the relevant information, such as numbers, descriptive text, proprietary codes, references to data stored in other areas of the same memory or different memories (including other network locations) or information that is used by a function to calculate the relevant data. Examples of such data include points rewarded to the operator of the interactive task organizer application, a level attained, tasks available, tasks completed, flight information, or any other information related to the interactive task organizer application.

The processor 120 may be any conventional processor which can be purchased at electronics stores. Alternatively, the processor may be a dedicated controller such as an ASIC. Although FIG. 2 functionally illustrates the processor and memory as being within the same block, it will be understood by those of ordinary skill in the art that the processor and memory may actually comprise multiple processors and memories that are or are not stored within the same physical housing. For example, memory may be a hard drive or other storage media located in a server farm of a data center. Accordingly, references to a processor, a computer, or a memory will be understood to include references to a collection of processors, computers, or memories that operate in parallel, in sequence, or independently.

The computer 110 may be any type of computing device, such as a desktop, laptop, notebook, tablet, handheld, or other computer. The computer 110 also includes an electronic display 150 (e.g., a monitor having a screen, a touch-screen, a projector, a television, a computer printer or any other electrical device that is operable to display information), and end user input 160 (e.g., a mouse, keyboard, touch-screen, microphone, or any other input device).

The computer 110 is communicatively coupled to an avionics system 220 of the aircraft. In this regard, the computer 110 receives flight information from the avionics system 220. For example, the avionics system 220 includes a navigation system 222 and an aircraft management system 224. The avionics system 220 provides information relating to fuel level, navigation, distance traveled, time, speed, altitude, orientation (pitch, yaw, roll), or the like.

The computer 110 may also be communicatively coupled to other nodes, for example, through a network 250. For example, the computer 110 may exchange information with a server 270 and client computer 280. For example, computer 110 shares performance information obtained in connection with the operator's use of the interactive task organizer application. Alternatively or additionally, the computer 110 shares messages, or any other information relative to the interactive task organizer application, with the server 270 and computer 280. Accordingly, operators using the computer 110 communicate with other pilots using the interactive task organizer application on the computer 280. Moreover, the computer 110 communicates with the server 270 to, for example, download updates, receive additional information, provide statistics, or the like.

Network 150, and intervening nodes between server 110 and client devices, comprises various configurations and uses various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Alternatively or additionally, the computers 110, 270, 280 communicate with each other over datalink, radio, satellite, or any other communication means typically used by aircrafts. Although only a few computers are depicted in FIG. 2, it should be appreciated that a typical system can include a large number of connected computers.

The server 270 and the client device 280 are configured similarly to the computer 110, with a processor, memory and instructions as described above. The server 270 and the client device 280 may each be a personal computer intended for use by a person, and have all of the components normally used in connection with a personal computer such as a central processing unit (CPU), memory (e.g., RAM and internal hard drives) storing data and instructions, an electronic display (e.g., a monitor having a screen, a touch-screen, a projector, a television, a computer printer or any other electrical device that is operable to display information), end user input (e.g., a mouse, keyboard, touch-screen or microphone).

Although the client device 280 comprises a full-sized personal computer, it may alternatively comprise a mobile device capable of wirelessly exchanging data with a server 270 or with the device 110 over a network such as the Internet. By way of example only, client device 280 is a wireless-enabled PDA or a cellular phone capable of obtaining information via the Internet. The user inputs information using a small keyboard, a keypad, or a touch screen.

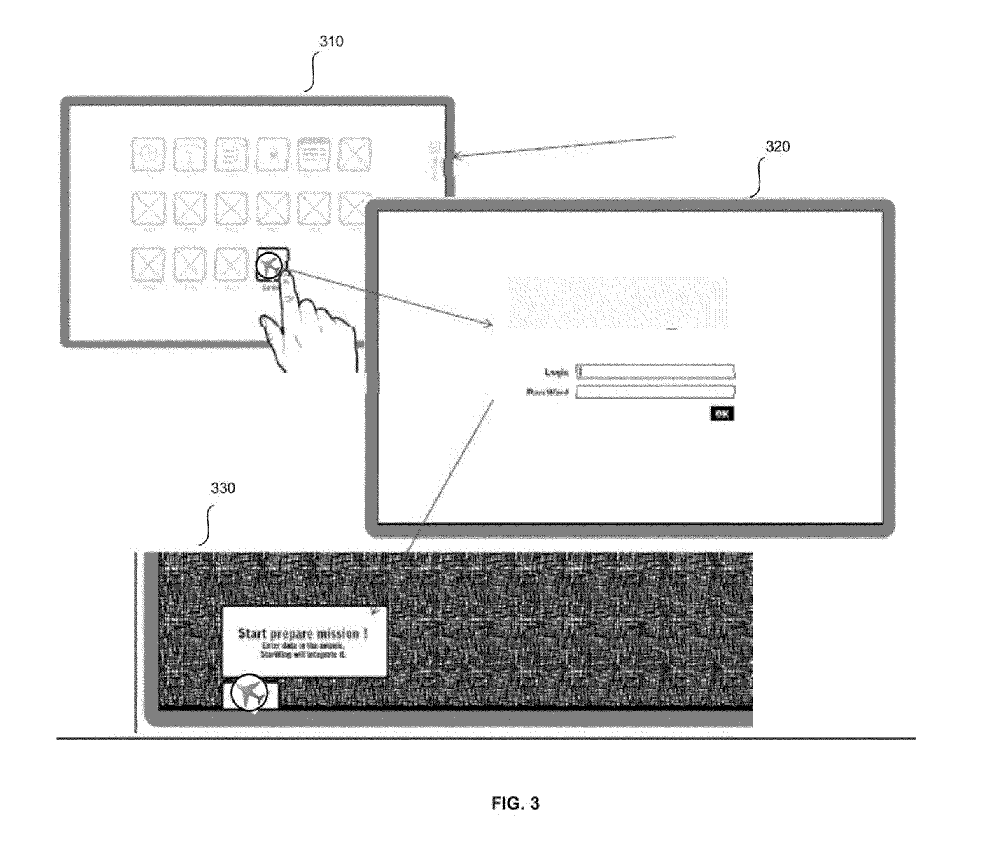

FIG. 3 provides examples of several screenshots which are encountered by an operator, such as a pilot, when launching the application. As shown in screen 310, the operator selects an icon 312, for example by tapping a touch-sensitive screen or clicking a mouse to select with a cursor. The operator is then required to log in (screen 320), and is encouraged to perform his tasks as usual (screen 330).

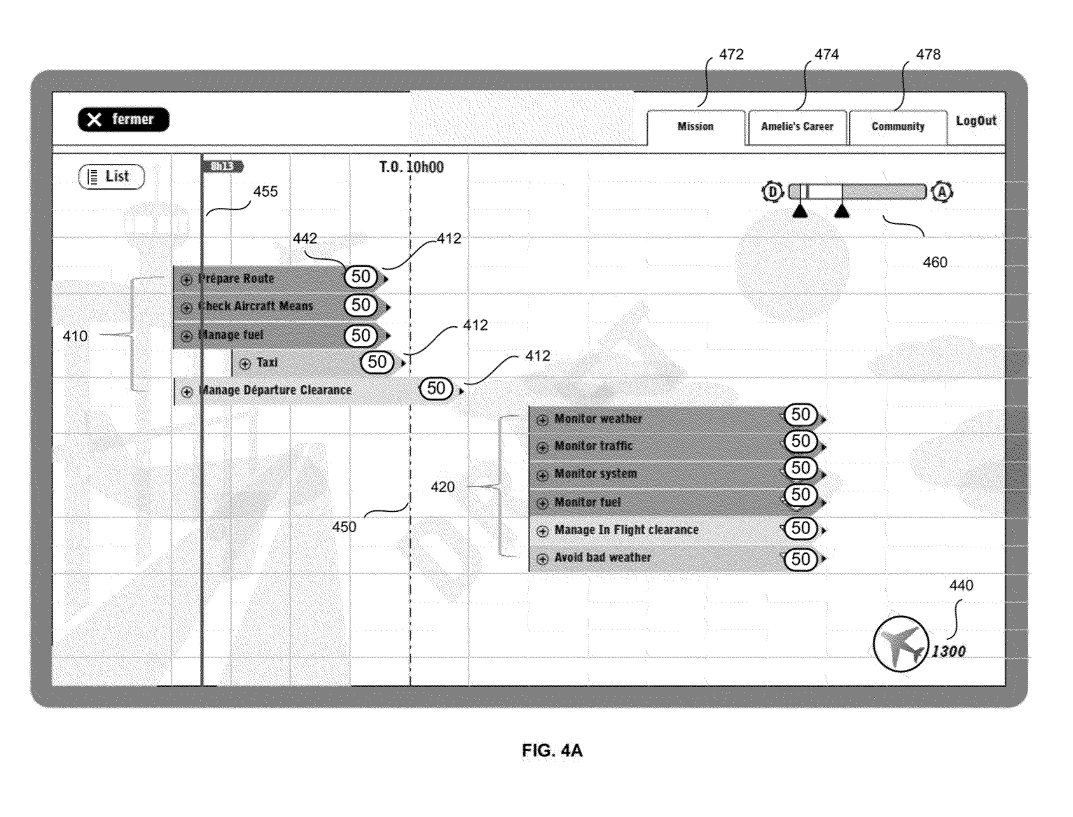

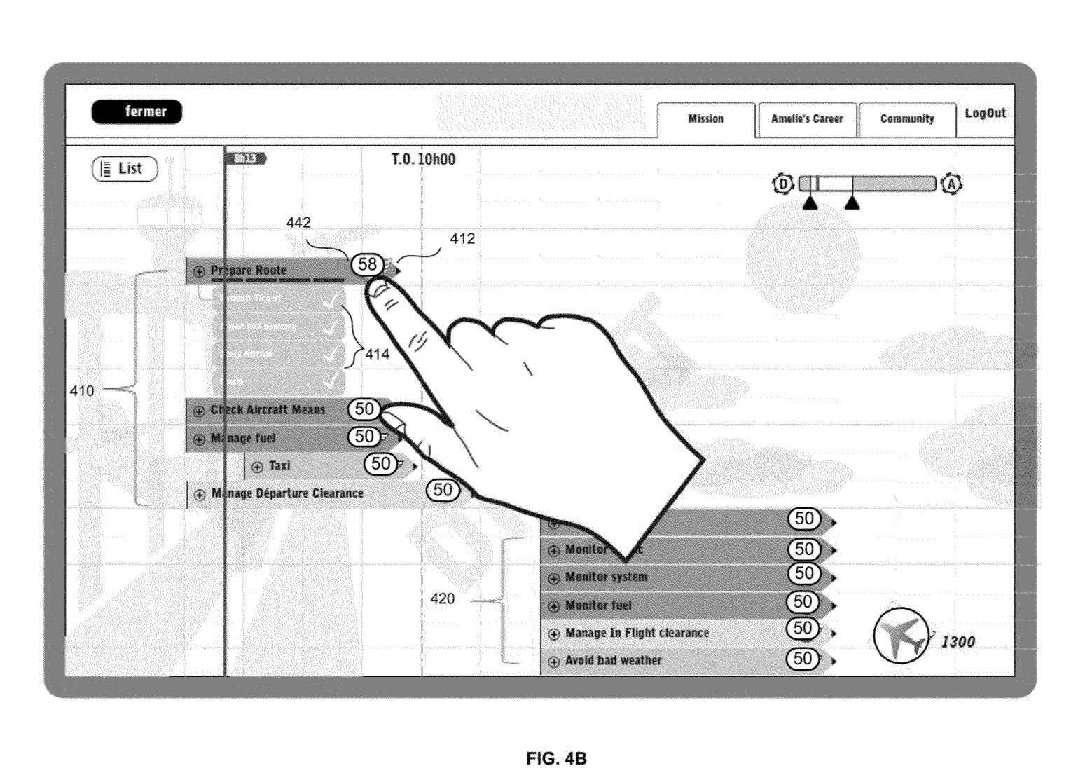

As shown in FIGS. 4A-4B, the application provides one or more lists 410, 420 of tasks to be performed by the operator. Each list 410, 420 of tasks includes one or more major tasks 412. For example, major tasks include prepare route, check aircraft means, manage fuel, taxi, manage departure clearance, monitor weather, monitor traffic, monitor system, monitor fuel, manage in-flight clearance, avoid bad weather, etc.

Further, some or all of the major tasks include one or more subtasks 414 (FIG. 4B). For example, the major task 412 “prepare route” includes subtasks 414 “check weather at departure,” “check weather at arrival,” “check en route altitude,” and “check NOTAMS.” Further, major task “order fuel” includes the subtasks “check take-off performance, check route, check load and trim sheet, and assess taxi fuel”. According to one example, the operator chooses whether or not to view the subtasks 414 associated with a given major task 412. For example, if the operator is less familiar with the details included within a major task 412, the operator selects to view the full list of subtasks 414 associated with that major task. In this regard, the operator verifies that he performs each of the subtasks 414 required to successfully complete the main task 412. Accordingly, when the pilot has time, and is therefore likely to lose motivation, he can refer to his to do list, see what he has left to do, and check what he has done.

According to one example, a different list is provided for each phase of the flight. Such phases may include, for example, takeoff, cruise, and landing. For example, the list 410 is associated with a takeoff phase, while the list 420, which includes a different set of tasks, is associated with a cruise phase. The task lists are contextualized for the operator graphically. For example, as shown in FIGS. 4A-4B, a takeoff indicator line 450 is shown. The task list 410, associated with takeoff, is displayed prior to or across the takeoff indicator line 450, thus providing the operator with a timeframe of when the tasks 410 should be performed. Moreover, the tasks are color-coded, such that each task corresponds to a particular category. Task categories include: mission, surveillance tasks; operate aircraft; communication; and system management related tasks.

According to some examples, the flight phase is obtained automatically from the avionics system of the aircraft. For example, the application retrieves the scheduled takeoff and landing times for the aircraft from the avionics system. The application also retrieves the current time, which is used to determine the current phase of the flight. Other information, such as altitude and whether landing gear is up or down, is also retrieved from the avionics system and can be used in determining the flight phase.

Each task has a beginning and an end in terms of time, and should be completed before its end. A flight status indicator line 455 is generated using information, such as time information, from aircraft calculators or other parts of the avionics system. In one example, the flight status indicator line 455 is generated based on a current time as compared to a scheduled time of takeoff. The position of the flight status indicator line 455 provides further guidance to the operator of when to perform the tasks 410, 420. According to some examples, the operator can move the tasks around to fit his agenda and priority. Moreover, the operator can tune the duration of each task, for example, by dragging the little black arrow at the end of each task.

As tasks are timely completed, rewards are issued to the operator. One example of such a reward is points. Each task is associated with a particular number of available points. As the tasks are completed, the associated points are attributed to the operator. Such points are indicated in a reward icon 442. Moreover, a total score 440 indicating a total number of points rewarded across all tasks of all flights is maintained and displayed to the operator.

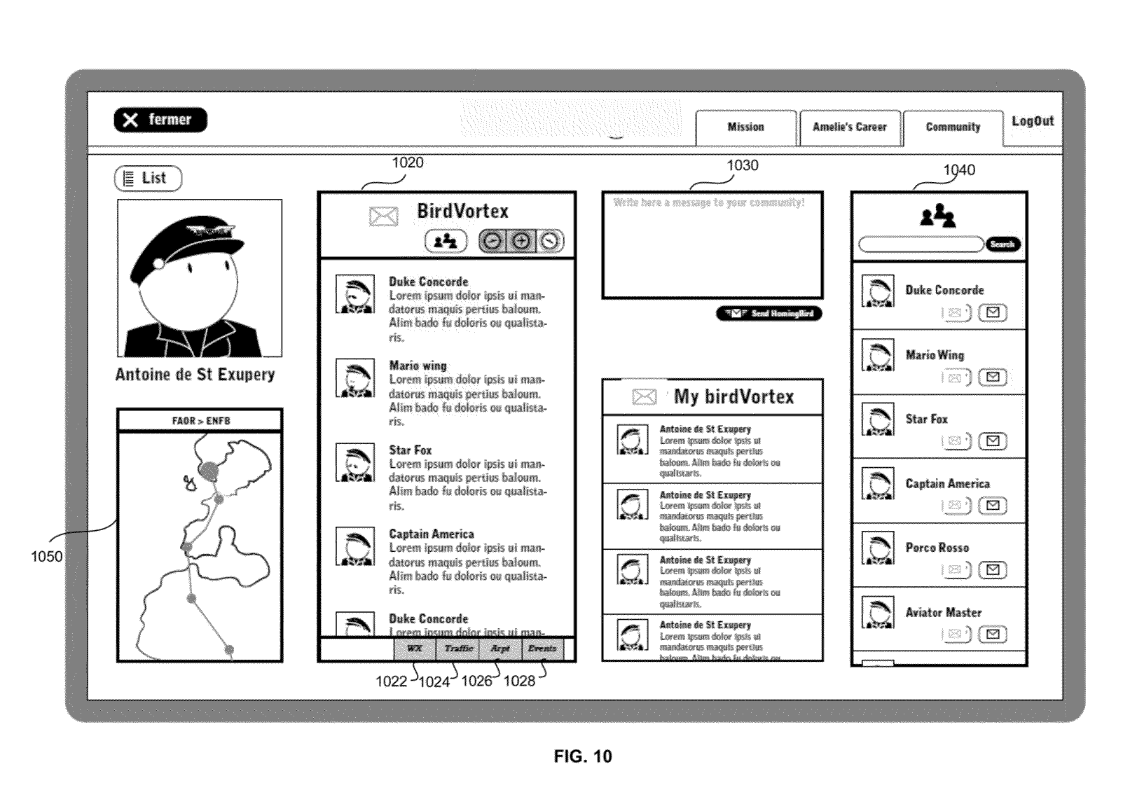

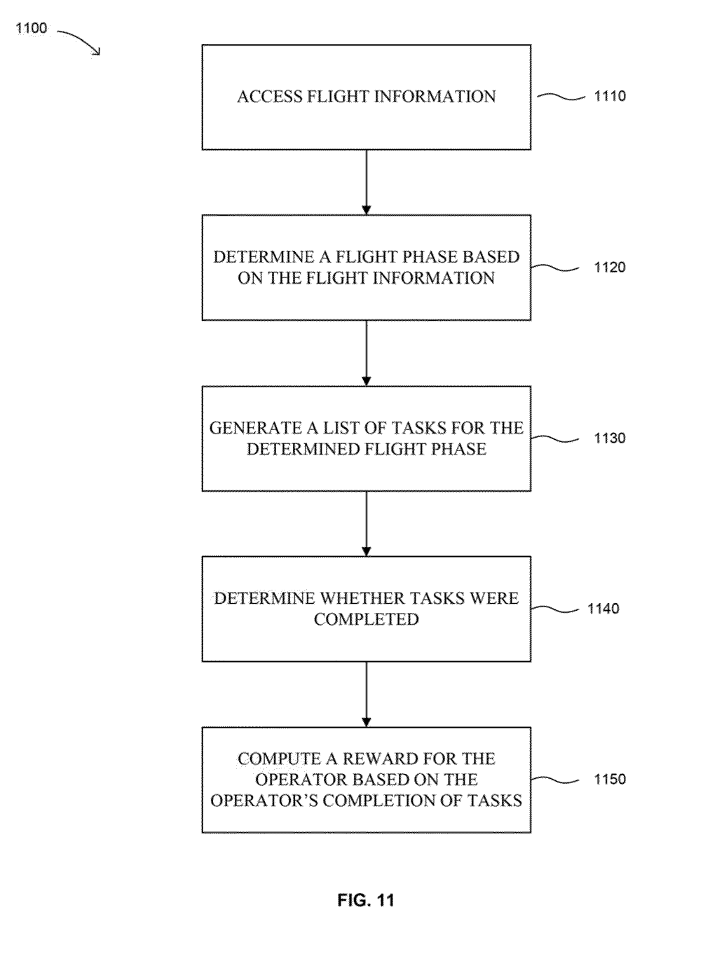

Various aspects of the application are available to the operator under different tabs 472, 474, 476. For example, the flight status and tasks interface are provided under a first tab 472, while career tab 474 and community tabs 476 provide different interfaces, discussed in more detail below (FIGS. 10-11).

A sliding view bar 460 enables the operator to change the timeframe viewed on the display. For example, the operator selects a narrow timeframe, including only the current phase on the flight. Alternatively, the operator selects to view a larger timeframe, such as the entire duration of the flight. According to another example, the operator selects to only view the current task list in a smaller window.

In some examples, the lists 410, 420 of tasks are edited based on received operator input. For example, depending on the level of expertise of the pilot, he tunes the major tasks by adding the subtasks he is less familiar with. As another example, major tasks are added to the lists 410, 420.

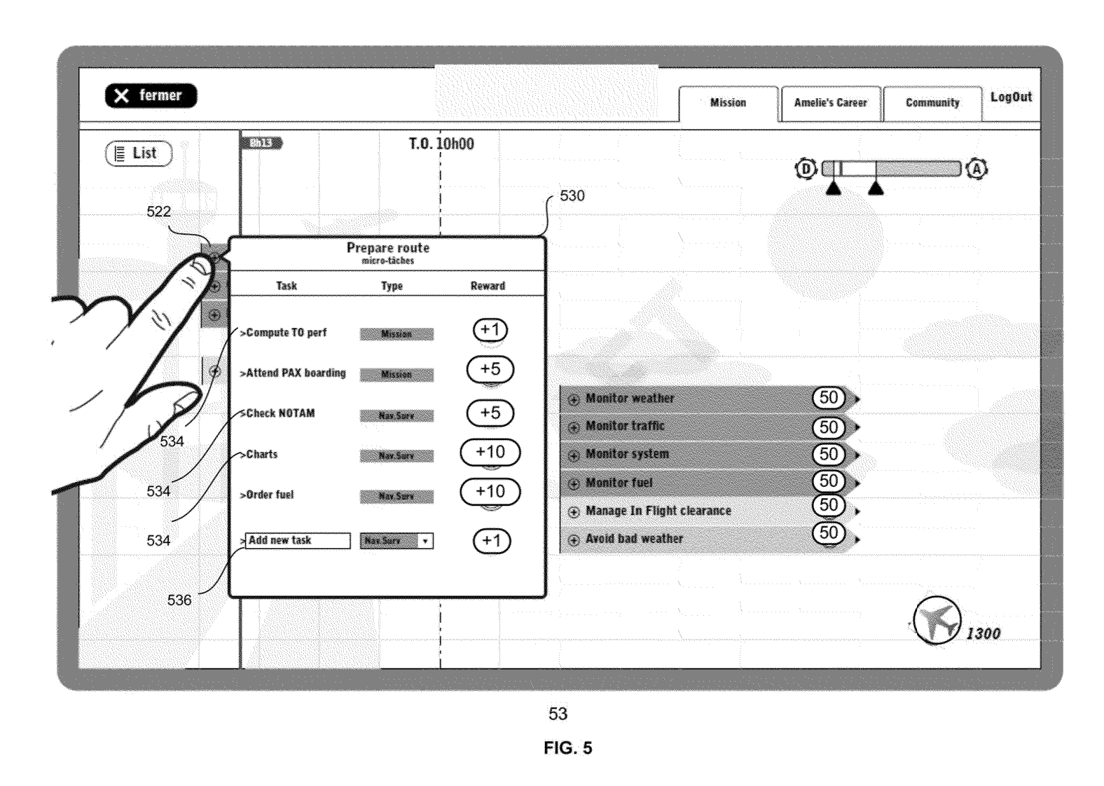

FIG. 5 illustrates an example of modifying the task list to add one or more subtasks. The operator receives a menu 530 of suggested subtasks 534, for example, in response to selecting an expansion icon 522 associated with a given major task. The menu 530 is different for each major task on a list. The operator selects the suggested subtasks 534 from the menu 530 that he wants to add to his task list. For example, the operator selects the suggested subtasks 534 that he is least familiar with, and therefore feels he may forget if they are not on his list. According to one example, an option 536 to add a new subtask is also provided.

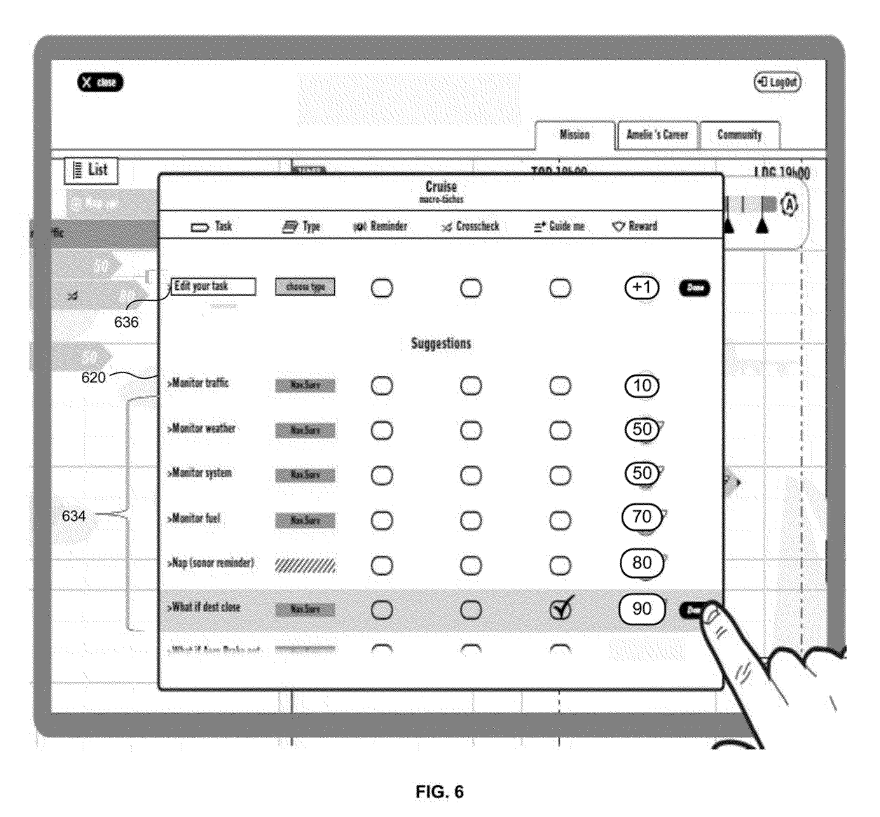

FIG. 6 illustrates an example of modifying the task list to add one or more major tasks. The operator enters a request, for example, by touching the background at the location where he wants to add the major task. A pop up window 620 is generated, displaying all the major tasks corresponding to the current flight phase of the aircraft. The window 620 includes one or more suggested major tasks 634. In this regard, the operator selects one of the suggested major tasks 634, options associated therewith, and adds it to his list. Examples of such options include whether the operator wants a reminder, if he wants a crosscheck, and if he wants guidance. The window 620 also includes a task entry area 636, where the operator can input a new major task that does not appear in the suggestions. For such tasks, the operator can also specify the task duration and the task category.

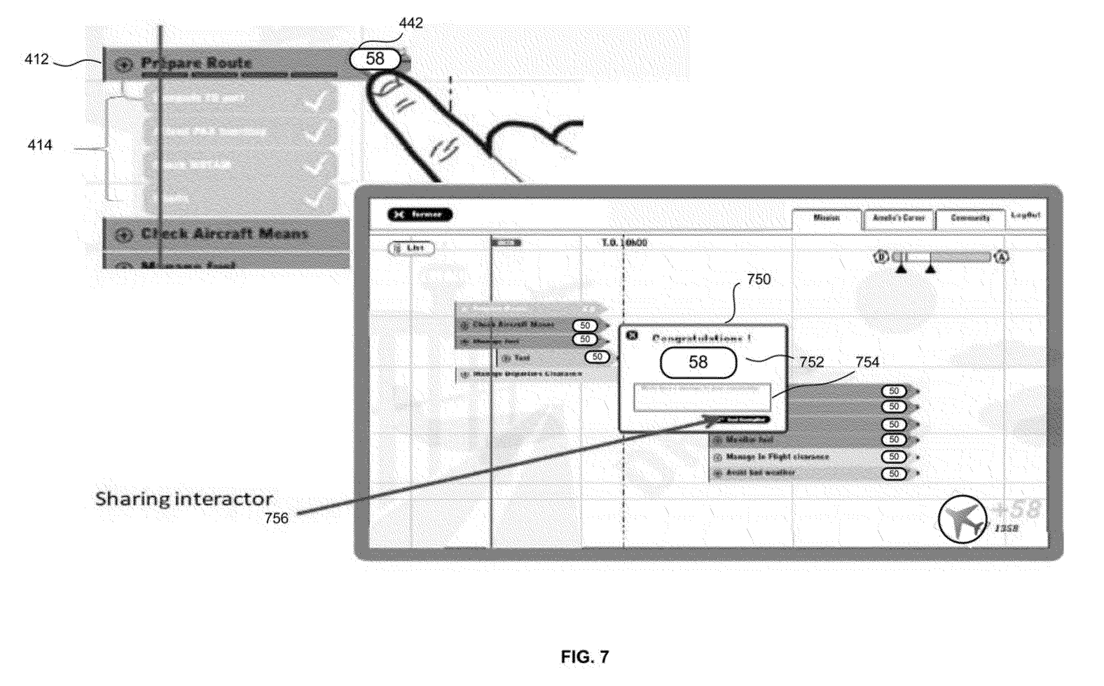

Completion of tasks is determined in any of a number of ways. For example, the operator manually indicates that the task has been completed, such as by pressing a particular button or icon. This example is discussed in more detail below with reference to FIG. 7. As another example, sensors and other devices are used to automatically detect whether the task has been completed. For example, a processor determines whether a particular button was pushed, system was accessed, or the like. Moreover, motion sensors, weight sensors, or other sensors are used to detect actions taken by the operator. As yet another example of determining whether a task was completed, the manual input of the operator is verified by automatic detection using the processor. This example, referred to as a crosscheck, is discussed in more detail below.

FIG. 7 provides one example of how completion of tasks is determined and corresponding rewards issued. According to this example, the operator manually inputs information as to whether the task has been performed. For example, referring to FIG. 7, the operator enters input indicating that each subtask 414 associated with a given task 412 has been completed. Such completion is signified by a checkmark next to the subtasks 414. Upon completion of each subtask 414, the operator receives a predetermined number of points. Alternatively, if the pilot does not wish to display the subtasks, he enters input to confirm that the major task 412 has been completed and therefore receive the reward. The points earned for the major task 412 may be shown in the reward icon 442. According to one example, the operator selects the reward icon 442 for further options. For example, upon selection of the reward icon 442, a reward message 750 is displayed. Such reward message 750 indicates the points rewarded 75, and also provides an interface for the operator to share his score. For example, the operator enters a message in a comments box 754, and shares his score and comments with others by selecting the share button 756.

According to one example, the operator selects certain options for each task, regardless of whether the task was automatically generated by the application or was added by the operator. Examples of such options include whether the operator wants a crosscheck, guidance, or a reminder.

By doing a crosscheck, the processor confirms that the operator performed a given task. Each major or sub task requires a corresponding action, and often this action is governed by codified procedures. For example, for the major task of checking the weather, required actions includes viewing the navigation display screen and pressing the “WX” button to display weather information on that display. These actions are verified using, for example, an eye-tracker device adapted to check if the pilot has looked at the navigation screen for more than xx seconds. Such an eye tracker device is implemented in the cockpit and provides data to the processor executing the application. Moreover, the processor can check whether the weather layer of information was activated on the navigation display.

Another example of crosschecking relates to the task of napping. This task includes, for example, sleeping 15 min and waking up at a scheduled time. To verify such action, presence sensors may be implemented in the aircraft. An alarm is emitted if the pilot is not awake and moving at the scheduled time. Moreover, the processor can recognize that the pilot did not request a reward for completion of the task of napping.

Yet another example of crosschecking relates to the task of communication. The processor determines whether the communication frequency was updated or validated. Moreover, a sound detector may be implemented to enable the processor to determine that the pilot spoke.

An even further example of crosschecking relates to the task of ordering fuel. The fuel order task is not marked completed until a message was sent via datalink from the aircraft to the fueler or the airline. While only a few examples of crosschecking have been provided, other tasks can be checked using, for example, presence sensors, eye trackers, detecting interaction with a button of the cockpit, detection touch interaction with a touch screen of the cockpit, gesture sensors, or the like.

The guidance option automatically adds all the subtasks to a major task, and provides the operator with contextualized additional information on how to perform each subtask. For example, upon request of the operator, the guidance option enables display of a tool or tip for completing each subtask.

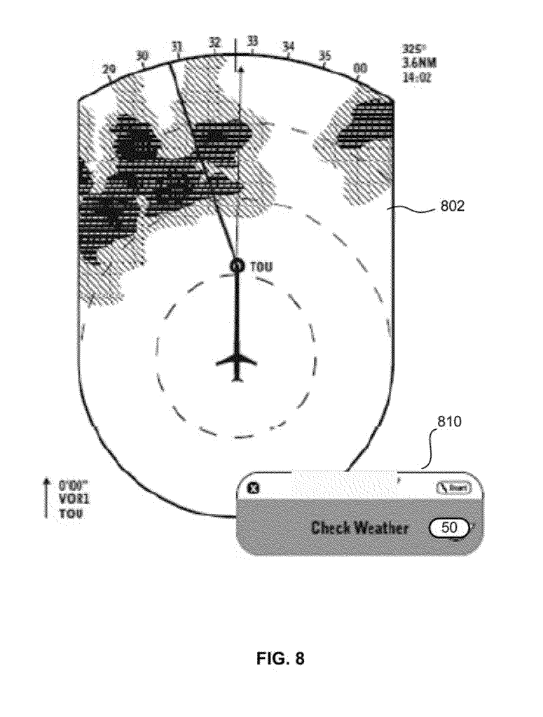

FIG. 8 illustrates an example of the reminder option. The reminder reminds the pilot of the task in his list prior the time it was planned to be finished. According to one example, the reminder appears contextualized on a screen of the cockpit where the task has to be performed. For example, as shown in FIG. 8, a horizontal display screen 802 is shown providing navigation information. On the screen 802, a reminder message 810 appears to remind the pilot to perform the task of checking weather. Reminders are spread to all appropriate applications, such as primary flight display, horizontal display, vertical display, engine monitoring displays, or the like, for display or other indication to the operator. For example, a reminder for the task of “monitor fuel” is provided on the aircraft monitoring display. A reminder for “check markers” is provided on the horizontal display and communication display. A reminder for “check vertical speed” is provided on the horizontal and primary flight displays. A reminder for “check speed” is provided on the primary flight display, and a reminder for the task “check com” is provided on the communication display.

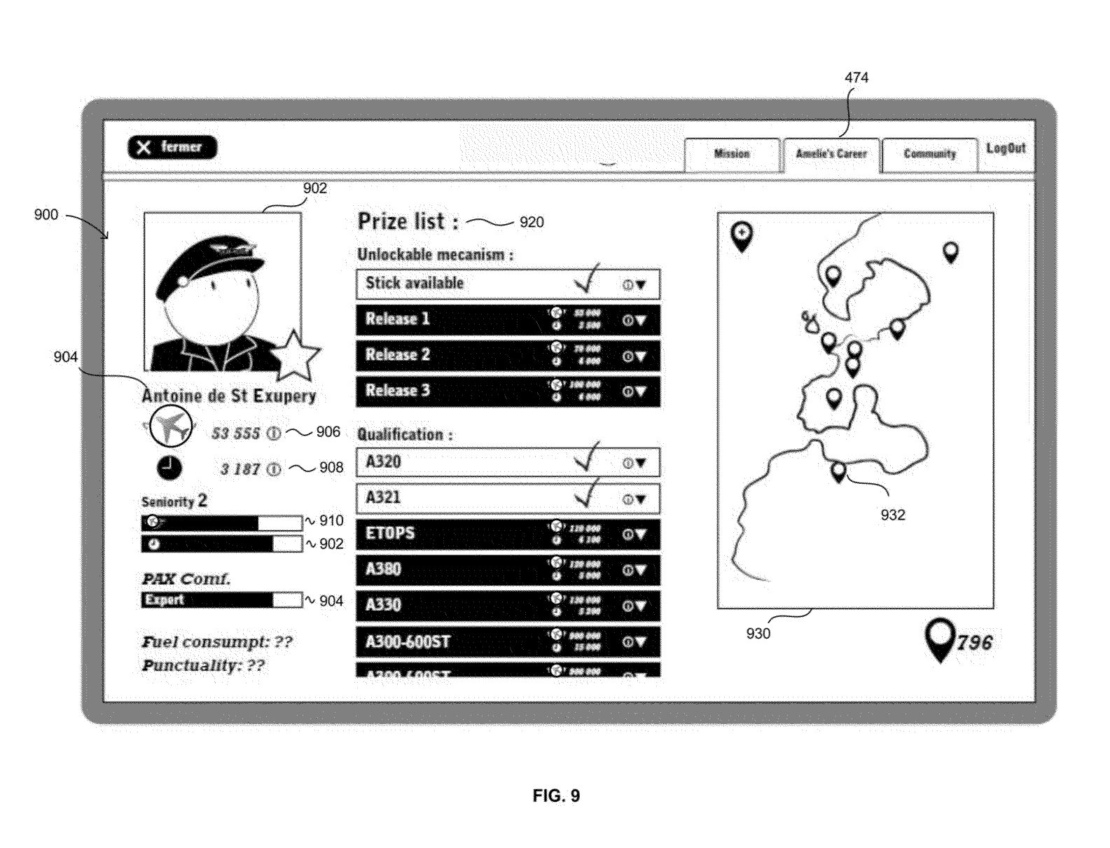

FIG. 9 illustrates an example of an aspect of the application which enables the operator to maintain a profile 900. The profile 900 appears, for example, under the career tab 474. The profile 900 includes, for example, a picture 902 of the operator, a name 904, and information regarding the operator's experience and rewards. Such information includes a total number of points rewarded 906 and a total number of hours spend piloting 908. The total points and total hours is also expressed as bar graphs 910, 912. The profile 900 also includes status information 914, for example, based on his past performance using the application. A prize list 920 lists the operator's skills and rewards received, and also provides guidance as to how to reach a next level of the application. A map 930 allows the operator to post pinpoints 932 corresponding to, for example, locations of the airports he has flown into or out of.

FIG. 10 illustrates an example of a “community” tab 476, which is a social networking aspect of the application. The community tab 476 enables the operator to communicate with others, such as other pilots, regarding information such as his current flight, his completion of tasks or subtasks, or the like. In one example, such communication takes the form of short messages broadcast to a predetermined group of other users. For example, a message board 1020 includes a number of messages posted by the operator or other users. According to one example, the messages are categorized using the filter buttons 1022, 1024, 1026, 1028. For example, the operator selects to view only messages relating to weather, traffic, airports, or events by clicking a corresponding one of the filter buttons 1022-1028. The operator also posts his own messages using, for example, text entry field 1030. A list of other users 1040 is provided to the operator. This list 1040 indicates the users associated with the operator (e.g., the operator's friends), the users currently available for communication through the application, or both. The operator also communicates through graphics or other forms, such as using map 1050 to communicate regarding the operator's route.

According to some aspects, the operator's communication is limited in time or duration. For example, communication is only available during cruise, such as during the several tens of minutes before landing and after takeoff. Moreover, the communication is limited to, for example, 10 minutes, for security and other reasons. Additionally, according to some aspects the content of the operator's messages is restricted. For example, only communications regarding weather, traffic, airports, and flight-related events are permitted, and other communications may be rejected.

FIG. 11 provides a flowchart illustrating a method 1100 according to aspects of the disclosure. The method 1100 is performed, for example, by a processing unit in communication with a set of data and instructions. The processing unit is an existing processor within an avionics system adapted for use with the present application. For example, the application is downloaded for execution by an existing processor in the avionics system with available capacity. Alternatively, a separate processor in communication with the avionics system is implemented to execute the application.

In block 1110, flight information is accessed. For example, information is obtained from the avionics system. Such information relates to a current time, scheduled times of takeoff and landing, fuel levels, onboard weight, weather, navigation, traffic, or the like.

In block 1120, a flight phase is determined based on the flight information. Examples of the flight phase include takeoff, cruise, and landing. According to some examples, the flight phase indicates a current time in relation to the time between departure and arrival of the aircraft.

In block 1130, a list of tasks for the determined flight phase is generated. Such list includes a number of major tasks, and each major task includes one or more subtasks. Each major task and subtask includes set time limits, wherein the task is required to be completed within that time limit. The tasks are displayed to an operator in relation to the flight phase. For example, a first list of tasks is displayed between times a and b, which is during takeoff. A second list of tasks is displayed between times c and d, which is during cruise.

In block 1140, it is determined whether the tasks were completed. Such determination are made by the processor, for example, based on received operator input. Alternatively or additionally, the determination is made by the processor based on communication with sensors or other aspects of the avionics system.

In block 1150, a reward for the operator is computer based on the operator's completion of the tasks. For example, if the operation completed 3 out of 5 subtasks corresponding to a major task, the operator receives a number of points corresponding to those 3 subtasks. However, such points are less than the total number of points available had the operator completed all 5 subtasks.

According to one example, the interactive task organizer application includes a number of levels, and the levels may be of increasing complexity. For example, an inexperienced pilot, participating at a lower level of the application, only receives a limited number of tasks to complete. In contrast, a more experienced pilot, participating at a more advanced level of the application, has increased options, tasks, and the like.

One option which may be available to operators is a “mini-game” to assist the pilot in his tasks when there is nothing happening in the environment and he has no task to perform. The mini-game takes the form of, for example, a 10 minute quiz. The quiz presents questions relevant to the operator's mission that require the operator to be cognizant of his surroundings. For example, the application asks the pilot whether he can take an additional 2000 pounds of cargo to his destination. The operator must study his environment to successfully answer the question. Correct answers are rewarded, for example, by attributing a number of points.

The foregoing application is used for various purposes. For example, in addition to motivating the pilot and maintaining his awareness, the application is used by airlines or other entities to evaluate pilots. For example, the application rewards points, and the pilot is prevented from modifying the reward of points. Based on the points rewarded to each pilot, the airline or other entity determines an experience level of pilots and a profile. For example, according to the category of tasks and the category of quiz questions in which the pilot performs well, the application indicates the pilot's strengths. This information is also useful, for example, in offering promotions, salary raises, change of grades, career orientation, etc.

Other advantages of the application include the provision of feedback to pilots. Feedback has been identified as a very important feeling for motivation. It also helps the pilot to be focused in his task and aware of his current environment. Moreover, allowing the pilot to add and tune his own list of tasks and subtasks increases the pilot's involvement and prompts action even when an autonomous system is in control.

The application also increases pilot motivation by setting up both high and low level goals for the pilot to achieve, and providing rewards based on their completion. Moreover, the pilot's ability to share his performance information with colleagues and receive positive feedback is another strong motivator.

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A method comprising:
providing an interface;
accessing flight information from an avionics system;
determining, using a processor, a flight phase based on the flight information;
providing a list of tasks for the determined flight phase to the user through the interface;
determining whether an operator has completed the tasks on the list; and
computing, using the processor, a reward for the operator based on the operator's completion of tasks in the list of tasks.

2. The method of claim 1, wherein the list of tasks comprises:
one or more major tasks; and
for at least one of the one or more major tasks, a subtask.

3. The method of claim 2, further comprising:
receiving operator input; and
editing the list of tasks based on the operator input.

4. The method of claim 3, wherein editing the list of tasks comprises adding subtasks to the one or more major tasks.

5. The method of claim 2, wherein:
the reward comprises an award of points; and
the points are awarded upon completion of each of the one or more major tasks.

6. The method of claim 1, wherein the flight phase comprises one of takeoff, landing, and cruise.

7. The method of claim 1, further comprising transmitting information regarding the reward to other operators.

8. The method of claim 1, further comprising:
receiving messages from other operator systems; and
displaying the received messages to the operator through the interface.

9. The method of claim 1, wherein determining whether an operator has completed the tasks on the list comprises automatically detecting, using the processor, an action of the operator.

10. The method of claim 9, wherein determining whether an operator has completed the tasks on the list further comprises receiving operator input relating to the completion of the task, and wherein the automatically detecting an action of the operator is performed as part of a cross-check.

11. A system comprising:
an interface;
a processor;
a memory in communication with the processor, the memory storing instructions executable by the processor for performing a method, the method comprising:
accessing flight information;
determining, using a processor, a flight phase based on the flight information;
providing a list of tasks for the determined flight phase to an operator through the interface;
determining whether the operator has completed the tasks on the list; and
computing a reward for the operator based on the operator's completion of each task.

12. The system of claim 11, wherein the list of tasks comprises:
one or more major tasks; and
for at least one of the one or more major tasks, a subtask.

13. The system of claim 12, wherein the system is adapted to:
receive operator input; and
edit the list of tasks based on the operator input.

14. The system of claim 11, wherein the interface comprises a touch-sensitive display.

15. The system of claim 12, wherein:
the reward comprises an award of points; and
the points are awarded upon completion of each of the one or more major tasks.

16. The system of claim 11, wherein the processor is in communication with an avionics system, and receives the flight information from the avionics system.

17. The system of claim 11, further comprising a transmitter adapted to transmit information regarding the reward to other operators.

18. The system of claim 11, further comprising a receiver adapted to receive messages from other operator systems.

19. A non-transitory computer readable medium storing instructions executable by a processor to perform a method, the method comprising:
providing an interface;
accessing flight information from an avionics system;
determining, using a processor, a flight phase based on the flight information;
providing a list of tasks for the determined flight phase to the user through the interface;
determining whether an operator has completed the tasks on the list; and
computing, using the processor, a reward for the operator based on the operator's completion of each task.

20. The non-transitory computer readable medium of claim 19, wherein the list of tasks comprises:
one or more major tasks; and
for at least one of the one or more major tasks, a subtask.
